(19) United States
(12) Patent Application Publication
(10) Pub. No.: US 2021/0310695 A1
(43) Pub. Date: Oct. 7, 2021

(54) HEATER TANK FOR HEAT PUMP SYSTEM AND METHOD FOR CONTROLLING HEATER TANK

(71) Applicant: LG ELECTRONICS INC, Seoul (KR)

(72) Inventors: Minsu PARK, Seoul (KR); Hyunjong Kim, Seoul (KR); Dongwon Sung, Seoul (KR); Yeol Lee, Seoul (KR); Kyungmok Yeo, Seoul (KR)

(73) Assignee: LG ELECTRONICS INC

(21) Appl. No.: 17/223,269

(22) Filed: Apr. 6, 2021

(30) Foreign Application Priority Data
Apr. 7, 2020 (KR) 10-2020-0042333

(51) Int. Cl. F24H 4/04; F24H 9/00; F24H 9/20; G05D 9/12

(52) U.S. Cl. CPC F24H 4/04; G05D 9/12; F24H 9/2021; F24H 9/0015

(57) ABSTRACT

A heater tank for a heat pump system having a structure in which a capacity of a storage space may be changed as hot fluid is discharged. For example, the heater tank may include a main body having an internal space and one open side, and a capacity changing member that forms a storage space, in which a hot fluid, such as water may be stored, by closing the one open side in the internal space of the main body, and being moved so that a capacity of the storage space may be changed as the hot fluid is discharged.

### CROSS-REFERENCE TO RELATED APPLICATION(S)

This application claims priority under 35 U.S.C. § 119 to Korean Application No. 10-2020-0042333, filed in Korea on Apr. 7, 2020, whose entire disclosure(s) is/are hereby incorporated by reference.

### BACKGROUND

### 1. Field

A heater tank for a heat pump system and a method for controlling a heater tank are disclosed herein.

### 2. Background

An eco-friendly heat pump system with a relatively high thermal efficiency may be installed for cooling, heating, or cooling and heating buildings. The heat pump system may be provided with a water-heater tank that stores hot water, such that when required by a user, the hot water may be provided to a user.

Generally, the water-heater tank for the heat pump system has a hot water capacity which is fixed at a predetermined value. That is, when hot water is discharged from the water-heater tank as a user uses the hot water, service water (city water or feed water) is introduced in an amount corresponding to an amount of the discharged water, so as to maintain a fixed capacity of hot water. The service water has a lower temperature than water placed in the water-heater tank, such that when the service water is introduced, high-temperature water and low-temperature water are present together in the water-heater tank. In this case, the low-temperature water has a higher density than the high-temperature water, such that stratification occurs, in which the high-temperature water is present at an upper side of the water-heater tank, the low-temperature water is present at a lower side thereof, and an intermediate layer (thermocline), where water temperature changes, is disposed therebetween.

In a general water-heater tank, stratification is maintained so that a temperature of water to be discharged may not be lowered. That is, while maintaining a temperature difference between the high-temperature water present at the upper side and the low-temperature water present at the lower side, a water outlet tube is provided on the upper side, so as to discharge and use the high-temperature water present on the upper side of the water-heater tank. Further, a water inlet tube is provided on the lower side of the water-heater tank so that water, introduced through the water inlet tube and having a relatively low temperature, may be present on the lower side.

However, stratification is significantly affected by velocity, and flow rate, for example, of the introduced service water, such that if a velocity or a flow rate of the service water is high, it is difficult to maintain stratification, such that the water temperature is difficult to be maintained constant at the upper side of the general water-heater tank. Further, in the general water-heater tank, heat exchange is performed by natural convection, and thus, is greatly affected by temperature, such that heat exchange may not take place if a difference in water temperature is reduced as low-temperature water is heated. Accordingly, the general water-heater tank has a problem in that a water discharge temperature may not be maintained constant, and heat exchange efficiency is low.

As an example of a related art, Chinese Patent Publication No. 102022830, which is hereby incorporated by reference, discloses a method of changing a hot water capacity. The related art discloses a method of changing an initial set value of the capacity of hot water, in which in order to maintain stratification, when hot water is used, water is introduced such that a capacity of the hot water is fixed. Accordingly, the related art still has the problem of maintaining stratification, and there is no substantial difference in position between a water outlet tube and a water inlet tube, such that the related art has limitations in maintaining discharged water at a high temperature.

### BRIEF DESCRIPTION OF THE DRAWINGS

Embodiments will be described in detail with reference to the following drawings in which like reference numerals refer to like elements, and wherein:

FIG. 1 is a schematic diagram of a heat pump system including a heater tank for a heat pump system according to an embodiment;

FIG. 2 is a schematic cross-sectional view of a heater tank for a heat pump system according to an embodiment;

FIG. 3 is a perspective view of a capacity changing member included in the heater tank illustrated in FIG. 2;

FIG. 4 is a perspective view of a portion of an outlet tube included in a heater tank according to another embodiment;

FIG. 5 is a cross-sectional view of a portion of an outlet tube included in a heater tank according to another embodiment; and

FIG. 6 is a flowchart of a method for controlling a heater tank for a heat pump system according to an embodiment.

### DETAILED DESCRIPTION

Reference will now be made to embodiments, examples of which are illustrated in the accompanying drawings. However, it will be understood that embodiments should not be limited to the embodiments and may be modified in various ways. In order to clearly and briefly describe embodiments, components that are irrelevant to the description will be omitted in the drawings, and like reference numerals are used throughout the drawings to designate the same or like elements.

Terms “module” and “unit” for elements used in the following description are given simply in view of the ease of the description, and do not carry any important meaning or role. Therefore, the “module” and the “part” may be used interchangeably.

Hereinafter, a heater tank for a heat pump system (hereinafter referred to as a “heater tank”) and a method for controlling a heater tank will be described below with reference to the accompanying drawings.

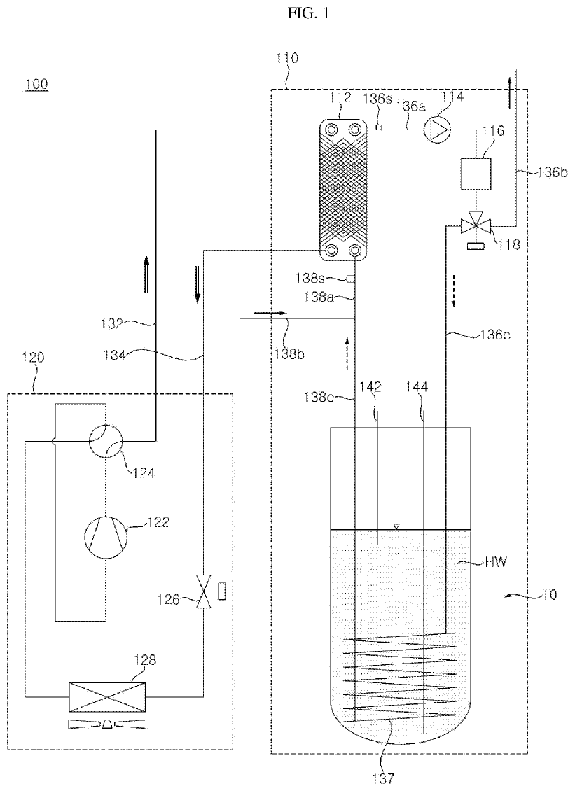

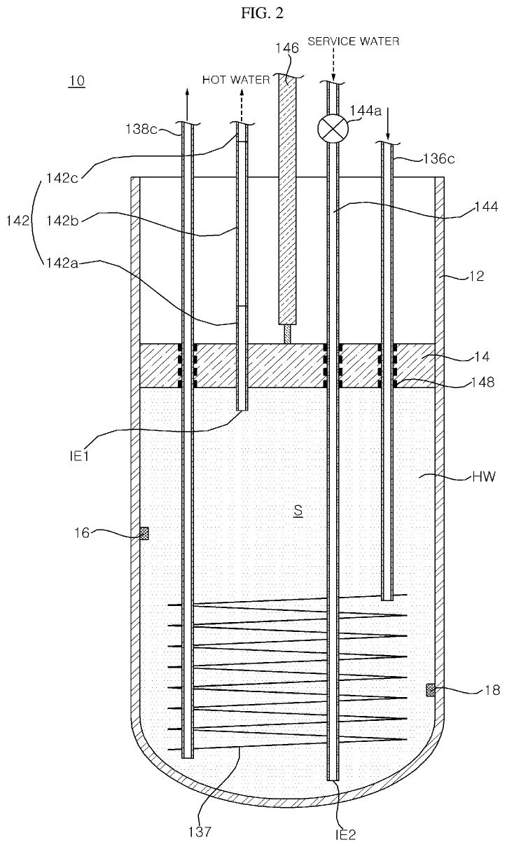

FIG. 1 is a schematic diagram of a heat pump system 100 including a heater tank 10 according to an embodiment. In FIG. 1 and in the following description thereof, only necessary elements of the heater tank 10 associated with the heat pump system 100 will be illustrated and given for simple illustration and better understanding, and the heater tank 10 will be described in further detail hereinafter with reference to FIGS. 2 to 5.

Referring to FIG. 1, the heat pump system 100 according to an embodiment may include an indoor unit 110 provided indoors and performing heat exchange between an interior and a refrigerant, and an outdoor unit 120 provided outdoors and performing heat exchange between an exterior and a refrigerant. In this case, the heat pump system 100 may include the heater tank 10 that stores a hot fluid HF, such as hot water and provides the stored hot fluid HF. For reference, service fluid, such as water, as used herein, may collectively refer to water, city water, or feed water, for example, which may circulate through base pipes 136a and 138a, heating pipes 136b and 138b, and hot fluid pipes 136c, 137, and 138c, and the hot fluid HF may refer to service water placed in or discharged from the heater tank 10.

The outdoor unit 120 may include a compressor 122, a 4-way valve 124, an expansion valve 126, and an outdoor heat exchanger 128, and the indoor unit 110 may include an indoor heat exchanger 112 and a circulation pump 114. In addition, the indoor unit 110 may further include an auxiliary heater 116, temperature sensors 136s and 138s, for example. In this embodiment, an integrated heater tank is provided in which the heater tank 10 is included in the indoor unit 110, and a 3-way valve 118 may be further included to control the flow of fluid in the indoor unit 110. Accordingly, a structure of the heat pump system 100 having the heater tank 10 may be simplified.

The compressor 122 may compress a low-pressure refrigerant into a high-pressure refrigerant. The 4-way valve 124 may control a cooling or heating operation, and may determine a direction of a refrigerant passage. For example, during a cooling operation, the 4-way valve 124 may direct refrigerant, compressed by the compressor 122, to the outdoor heat exchanger 128, and during a heating operation, the 4-way valve 124 may direct the refrigerant to the indoor heat exchanger 112. The expansion valve 126 may adiabatically expand a liquid refrigerant into a low-pressure refrigerant. The outdoor heat exchanger 128 may serve as an evaporator during the heating operation, and may serve as a condenser during the cooling operation. The indoor heat exchanger 122 may serve as a condenser during the heating operation, and may serve as an evaporator during the cooling operation.

In this embodiment, various structures, and methods, for example, may be applied to the compressor 122, the 4-way valve 124, the outdoor heat exchanger 128, or the indoor heat exchanger 112. For example, the indoor heat exchanger 112 may be formed as a plate heat exchanger, having a large heat transfer area providing a high heat transfer capacity, and the heat transfer area may be adjusted easily by adjusting a number of plates. However, embodiments are not limited thereto, and various other structures, and methods, for example, may be applied to the indoor heat exchanger 112.

The following description will be focused on an example in which the heat pump system 100 operates as a heating device for implementing a heating mode for increasing the indoor temperature. However, embodiments are not limited thereto, and the heat pump system 100 may operate as a cooling and heating device by implementing both the heating and cooling modes.

The indoor unit 110 and the outdoor unit 120 may be connected to each other by first and second refrigerant flow tubes 132 and 134 serving as flow passages of the refrigerant. Further, base supply pipe 136a that supplies hot fluid and base return pipe 138a that returns the service fluid after being heated may be connected to the indoor heat exchanger 112. The circulation pump 114 that provides a drive force for circulation of the service fluid may be provided for the base supply pipe 136a. In addition, the auxiliary heater 116 for further heating the service fluid may be provided for the base supply pipe 136a so as to improve thermal efficiency, but the auxiliary heater 116 is not an essential component and may be omitted. In this case, the temperature sensors 136s and 138s that sense a temperature of the fluid flowing through the base supply pipe 136a and the base return pipe 138a may be provided.

In this embodiment, an indoor heating mode for heating the indoor space may be performed along with a fluid heating mode for heating the hot fluid HF. That is, in the indoor heating mode, service fluid supplied from the base supply pipe 136a may circulate through the heating pipes 136b and 138b, and in the fluid heating mode, service fluid supplied from the base supply pipe 136a may circulate through the hot fluid pipes 136c, 137, and 138c. Along with the heating pipes 136b and 138b, in particular, the heating pipe 136b, and the hot fluid pipes 136c, 137, and 138c, in particular, the supply pipe 136c, the base supply pipe 136a may be connected to the 3-way valve 118. Further, the return pipe 138b of the heating pipes 136b and 138b and the return pipe 138c of the hot fluid pipes 136c, 137, and 138c may be connected to the base return pipe 138a. The 3-way valve 118 controls the service fluid, supplied from the base supply pipe 136a, to circulate through the heating pipes 136b and 138b in the indoor heating mode, and to circulate through the hot fluid pipes 136c, 137, and 138c in the fluid heating mode.

In this embodiment, a connection structure of the base pipes 136a and 138a, the heating pipes 136b and 138b, and the hot fluid pipes 136c, 137, and 138c, for example, is merely an example, and may be modified in various ways. In addition, various known structures, and methods, for example, may be applied to the circulation pump 114, the auxiliary heater 116, the 3-way valve 118, and the temperature sensors 136s and 138s.

In addition, the heater tank 10 may have a storage space (S of FIG. 2, the same applies hereinafter) in which the hot fluid HF is stored, and may include an outlet tube 142, through which the hot fluid HF is discharged from the storage space S, and an inlet tube 144 that provides service fluid to the storage space S. In this embodiment, a heat exchanger that heats the service fluid or the hot fluid HF stored in or introduced into the heater tank 10 may be provided in the heater tank 10. That is, an immersed heat exchanger may be configured in such a manner that a coil 137 for circulation of hot fluid, which connects the supply pipe 136c and the return pipe 138c of the hot fluid pipes 136c, 137, and 138c, may be disposed in the storage space S of the heater tank 10.

For simple illustration, FIGS. 1 and 2 only schematically illustrate a shape of the coil 137 for circulation of hot fluid, but the coil 137 for circulation of hot fluid may be formed as a pipe, having a coil shape, through which hot fluid, having a high-temperature after being heat-exchanged by the indoor heat exchanger 112, flows. In this manner, the heat exchanger is disposed inside the storage space S, such that the service fluid or the hot fluid HF stored in or introduced into the storage tank 10 may be heated effectively. However, embodiments are not limited thereto, and the heat exchanger that heats the service fluid or the hot fluid HF stored in or introduced into the heater tank 10 may also be disposed outside of the heater tank 10 to heat the hot fluid HF or the service fluid by radiation, or conduction, for example, and various other modifications may be made.

In the heating mode, such as the indoor heating mode or the fluid heating mode, a high-temperature and high-pressure gaseous refrigerant, compressed by the compressor 122, may flow toward the indoor heat exchanger 112 by the 4-way valve 124, as indicated by a double-line arrow in FIG. 1. The high-temperature and high-pressure gaseous refrigerant is converted into a liquid refrigerant by passing through the indoor heat exchanger 112, and pressure of the refrigerant drops as the refrigerant passes through the expansion valve 126, such that the refrigerant is converted into a low-temperature and low-pressure liquid refrigerant. The low-temperature and low-pressure liquid refrigerant is guided to the outdoor heat exchanger 128, and is evaporated by absorbing heat from outdoor cold air at the outdoor heat exchanger 128, to be converted into a gaseous refrigerant and guided by the 4-way valve 124 to flow to the compressor 122. The heating mode may be performed by continuously repeating the above process.

In this case, the service fluid, having high temperature after being heat-exchanged by the indoor heat exchanger 112, may circulate through the heating pipes 136b and 138b in the indoor heating mode as indicated by a solid line arrow in FIG. 1; and in the fluid heating mode, the service fluid may circulate through the hot fluid pipes 136c, 137, and 138c to heat the service fluid or the hot fluid HF stored in the heater tank 10, as indicated by a dotted line arrow in FIG. 1.

For circulation of the refrigerant and the service fluid in the aforementioned heater tank 10 and the heat pump system 100 including the same, and controlling on/off of the heating mode, the indoor heating mode, and the fluid heating mode, for example, various members included in the heater tank 10 and the heat pump system 100 including the same may be controlled by controllers. A controller that controls the indoor unit 110, a controller that controls the heater tank 10, and/or a controller that controls the outdoor unit 120, for example, may be provided together or separately, and various structures, and methods, for example, may be applied thereto.

The heater tank 10 according to an embodiment, included in the heat pump system 100, will be described hereinafter with reference to FIGS. 2 to 5.

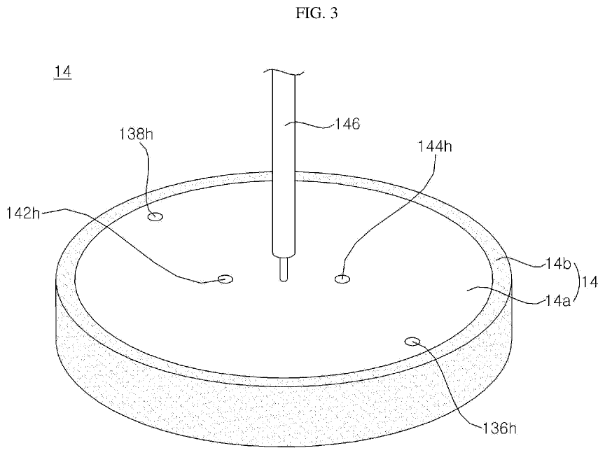

FIG. 2 is a cross-sectional view schematically of heater tank 10 included in heat pump system 100 according to an embodiment. FIG. 3 is a perspective view of a capacity changing member 14 included in the heater tank 10 illustrated in FIG. 2.

Referring to FIGS. 2 and 3, the heater tank 10 according to an embodiment may include a main body 12 having an internal space and one open side; and the capacity changing member 14 which forms the storage space S that stores the hot fluid HF by closing one side of the internal space of the main body 12, and which moves so that a capacity of the storage space S may be changed. In addition, the heater tank 10 may further include a drive 146, the outlet tube 142, the inlet tube 144, a flow rate control valve 144a, a reference level sensor 16, and a temperature sensor 18, for example, which will be described hereinafter.

The heater tank 10 may include the storage space S, in which the hot fluid HF is placed, and the internal space in which the capacity changing member 14 forming the storage space S is disposed. In this embodiment, the heater tank 10 has one open side, for example, an upper side, and the capacity changing member 14 forms the storage space S by closing the one side, for example, the upper side, of the internal space. In this structure, the heater tank 10 may have a simple shape, and the storage space S may be easily sealed by the capacity changing member 14 disposed on the one side of the internal space. Further, the capacity of the storage space S may be easily changed as the capacity changing member 114 moves in one direction, for example, an upward-downward direction. In this case, if the capacity changing member 14 is disposed at an upper portion and the storage space S that stores the hot fluid HF is disposed below the capacity changing member 14, the hot fluid HF may be placed stably, such that stability may be improved. The main body 12 may be made of various materials having excellent insulation characteristics so that a temperature of the hot fluid HF placed therein may not be lowered easily, and having high corrosion resistance so that corrosion may not occur due to the hot fluid HF, for example.

The capacity changing member 14 is disposed in the internal space of the heater tank 10, and by closing the one open side of the heater tank 10, the capacity changing member 14 may form a fluid-tight structure in which the storage space S is separated from the outside. As the fluid-tight structure is formed by the capacity changing member 14 as described above, excellent insulation characteristics may be obtained, thereby effectively preventing reduction in temperature of the hot fluid placed in the storage space S. For example, the capacity changing member 14 may be formed as a plate having a planar shape, which coincides with a planar shape of the main body 12, and having a predetermined thickness. That is, the capacity changing member 14 may be an upper plate, a top panel, or a top cover, for example.

For example, as illustrated in FIG. 3, the capacity changing member 14 may include an inner portion 14a having excellent insulation characteristics and made of a hard material, and a pressed portion 14b formed along an outer edge of the inner portion 14a and made of an elastic material, for example, rubber, or a soft material, for example, resin. Accordingly, while improving insulation characteristics using the inner portion 14a, an excellent fluid-tight structure may be obtained by the pressed portion 14b. The inner portion 14a may be made of a material having better insulation characteristics than the pressed portion 14b, and capable of maintaining a desired shape, and may be made of various materials, such as a resin, or metal, for example. The pressed portion 14b may be formed as an O-ring member, for example, and more particularly, a dynamic O-ring, which may be moved easily under pressure while maintaining sealing characteristics.

For example, the inner portion 14a may have a first hole 142h, through which the outlet tube 142 passes, a second hole 144h, through which the inlet tube 144 passes, a third hole 136h, through which the supply pipe 136c passes, and a fourth hole 138h, through which the return pipe 138c passes. Positions, arrangements, and shapes, for example, of the first hole 142h, the second hole 144h, the third hole 136h, and the fourth hole 138h may be modified variously.

In addition, the drive 146 that provides a drive force for moving the capacity changing member 14 may be coupled to the capacity changing member 14. The drive 146 may employ various structures, shapes, or methods, for example, for moving the capacity changing member 14. In this embodiment, the drive 146 may be formed as a cylinder, for example, hydraulic cylinder, which allows for a simple structure for moving the capacity changing member 14 to a desired position with a strong drive force. For example, FIG. 3 illustrates a structure in which one drive 146 is disposed at a center of the capacity changing member 14, thereby stably providing the drive force throughout the capacity changing member 14 in a simplified structure. However, embodiments are not limited thereto, and various modifications may be made, including providing a plurality of capacity changing members 14, for example.

In this embodiment, once the hot fluid HF is discharged such that a volume of the hot fluid HF in the main body 12 is reduced, the drive 146 may serve to move the capacity changing member 14 according to the reduced volume of the hot fluid HF. That is, when the hot fluid is discharged such that the volume of the hot fluid is reduced, the drive 146 moves the capacity changing member 14 downwardly, so as to reduce the storage space S in which the hot fluid is placed. Further, when hot fluid HF is insufficient such that a predetermined amount of service fluid is introduced, the drive 146 moves the capacity changing member 14 upwardly, so as to increase the storage space S in which the hot fluid HF is placed.

In this case, the drive 146 may adjust a position of the capacity changing member 14 using various methods. In this embodiment, in another example, the capacity changing member 14 may be formed as a floating disk, which floats on the hot fluid HF. Accordingly, by balance achieved between buoyancy of the capacity changing member 14 and the drive force of the drive 146, the capacity changing member 14 may float on the surface of the hot fluid HF, thereby forming a fluid-tight structure. In this manner, even when the hot fluid HF is discharged, the capacity changing member 14 may stably form the fluid-tight structure.

However, embodiments are not limited thereto. In yet another example, by providing a fluid level sensor that senses a fluid surface position of the hot fluid HF, the position of the capacity changing member 14 may be adjusted based on a fluid level sensed by the fluid level sensor. In still another example, by measuring a fluid discharge amount using a fluid discharge amount sensor provided for the outlet tube 142, a fluid surface position of the hot fluid HF may be identified, and a position of the capacity changing member 14 may be adjusted based on the identified position. In still another example, by sensing a temperature of supplied service fluid and an amount of the supplied fluid using a temperature sensor and a fluid supply amount sensor provided for the inlet tube 144, a fluid surface position of the hot fluid HF may be identified based on the sensed information, and a position of the capacity changing member 14 may be adjusted accordingly.

Further, the capacity changing member 14 may be provided with the outlet tube 142, through which the hot fluid HF is discharged, and the inlet tube 144 through which the service fluid is introduced. In this case, an inner end portion IE1 of the outlet tube 142 may be positioned adjacent to the capacity changing member 14, so that the hot fluid HF placed at one side of the storage space S, for example, an upper side of the storage space S, which is adjacent to the capacity changing member 14, may be discharged, thereby allowing the hot fluid HF having a relatively high temperature may be discharged. By contrast, an inner end portion IE2 of the inlet tube 144 may be positioned far away from the capacity changing member 14, so that service fluid having a relatively low temperature may be introduced into the other side of the storage space S, for example, a lower side of the storage space S, which is disposed far away from the capacity changing member 14. In this manner, the service fluid may be introduced into a portion where the coil 137 for circulation of hot fluid is disposed, which heats the service fluid or the hot fluid HF stored in or introduced into the heater tank 10, thereby allowing the service fluid to be heated effectively.

In this embodiment, the position of the capacity changing member 14 is changed according to the fluid discharge amount of the hot fluid HF as described above, in which the outlet tube 142, which is dependent on the capacity changing member 14, moves along with the capacity changing member 14, thereby allowing the hot fluid HF to be discharged at a portion adjacent to the capacity changing member 14. That is, even when the capacity changing member 14 moves, a constant distance may be maintained between the inner end portion IE1 of the outlet tube 142 and the capacity changing member 14.

The outlet tube 142 may have a first fixed portion 142a unmovably fixed to the capacity changing member 14 while having the inner end portion IE1, and may have a variable length portion 142b disposed on an outer side of the capacity changing member 14 and having a variable length. For example, the first fixed portion 142a of the outlet tube 142 may be unmovably fixed to the capacity changing member 14 by passing through the first hole 142h.

FIG. 2 illustrates an example in which the variable length portion 142b, connecting the first fixed portion 142a and a second fixed portion 142c connected to the outside, is made of a different material from the first and/or second fixed portions 142a and 142c. For example, the variable length portion 142b may be made of a flexible material, or an elastic material, for example, such that the length may be changed according to characteristics of the flexible material, or the elastic material, for example. By contrast, the first and second fixed portions 142a and 142c may be made of a hard material to improve connection stability with the outside and to prevent damage, such as corrosion, for example. In this manner, while improving structural stability and reliability of the outlet tube 142 in a simple structure, the inner end portion IE1 of the outlet tube 142 may be stably moved to a desired position by movement of the capacity changing member 14.

In this case, FIG. 2 illustrates an example in which the variable length portion 142b having a different material is disposed between the first and second fixed portions 142a and 142c; however, embodiments are not limited thereto. Accordingly, without providing the second fixed portion 142c, the entire outer side, except the first fixed portion 142a, may be formed as the variable length portion 142b made of a flexible material or a rubber material, for example.

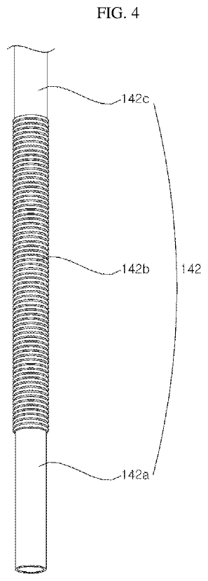

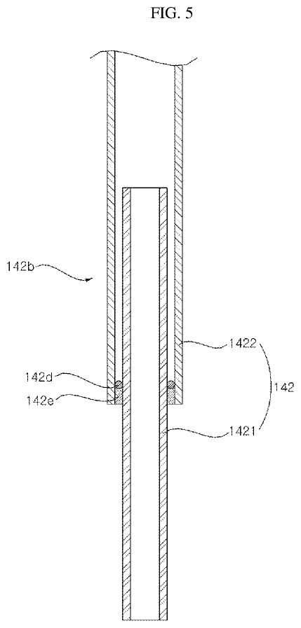

Further, the variable length portion 142b and the outlet tube 142 including the same may have various structures, methods, or shapes, for example, in addition to the structure described with reference to FIG. 2. Various examples thereof will be described hereinafter with reference to FIGS. 4 and 5.

FIG. 4 is a perspective view of a portion of outlet tube 142 included in heater tank 10 according to another embodiment. Referring to FIG. 4, the variable length portion 142b of the outlet tube 142 according to this embodiment may be formed as a corrugated tube with a plurality of corrugations formed in a circumferential direction. That is, the length of the variable length portion 142b may be changed in such a manner that when the corrugations of the variable length portion 142b extend, the length increases, and when the corrugations of the variable length portion 142b are folded, the length is reduced. While FIG. 4 illustrates an example in which the variable length portion 142b in the form of a corrugated tube is provided between the first and second fixed portions 142a and 142c, embodiments are not limited thereto. Accordingly, without providing the second fixed portion 142c, the entire outer side, except the first fixed portion 142a, may be formed as the variable length portion 142b in the form of a corrugated tube.

FIG. 5 is a cross-sectional view of a portion of outlet tube 142 included in heater tank 10 according to another embodiment. Referring to FIG. 5, the outlet tube 142 according to this embodiment may have a double pipe structure and may include variable length portion 142b. That is, the outlet tube 142 has a double pipe structure with a variable length of an overlapping portion of an inner tube 1421 and an outer tube 1422, in which the length of the outlet tube 142, for example, the variable length portion 142b, may be changed according to a variable length of the overlapping portion. A guide member or guide 142d for relative movement of the inner tube 1421 and the outer tube 1422, a sealing member or seal 142e that seals a space therebetween, for example, may be disposed between the inner tube 1421 and the outer tube 1422. Various bearing members, and linear movement members, for example, may be used as the guide member 142d, and various known sealing member 142e may be used as the sealing member 142d. FIG. 5 illustrates an example in which a portion of the inner tube 1421 forms the first fixed portion 142a fixed to the capacity changing member 4, and the outer tube 1422 forms the outer portion and is movably installed. However, embodiments are not limited thereto, and various modifications may be possible in which a portion of the outer tube 1422 forms the first fixed portion 142a fixed to the capacity changing member 4, and the inner tube 1421 forms the outer portion and is movably installed.

Referring back to FIGS. 2 and 3, the inlet tube 144 may be fixed to the capacity changing member 14, and may include the flow rate control valve 144a. For example, the inlet tube 144 may be disposed to pass through the second hole 144h formed in the capacity changing member 14.

In this case, the inlet tube 144 may be provided with the flow rate control valve 144a. The flow rate control valve 144a may be basically closed when the hot fluid HF is discharged, so as to prevent the service fluid from flowing into the heater tank 10 when the hot fluid HF is discharged. Further, when the hot fluid HF is not discharged, the flow rate control valve 144a may be opened if necessary, so that the service fluid may flow into the heater tank 10, thereby preventing a problem of stratification, for example, occurring due to inflow of the service fluid having a lower temperature than the hot fluid HF in the heater tank 10, which will be described hereinafter.

Various valves capable of controlling a flow rate may be used as the flow rate control valve 144a. For example, a solenoid valve, which is an opening/closing valve, may be used as the flow rate control valve 144a. Accordingly, when a supply of service fluid is needed, the flow rate control valve 144a may be opened, and when it is necessary to block the supply of service fluid, the flow rate control valve 144a may be closed, thereby stably allowing or blocking the supply of service fluid. More particularly, by using the solenoid valve as the flow rate control valve 144a, effects, such as a high reaction velocity, excellent stability, low leakage, and excellent service life, for example, may be obtained. However, embodiments are not limited thereto, and the flow rate control valve may be formed as a valve that controls an amount of supplied fluid, as well as for allowing and blocking the supply of service fluid.

Further, the supply pipe 136c and the return pipe 138c, through which the service fluid heat-exchanged by the indoor heat exchanger 112 in the fluid heating mode circulates, may be fixed at the third hole 136h and the fourth hole 138h of the capacity changing member 14, respectively.

The outlet tube 142 is required to move along with the capacity changing member 14 while being dependent on the capacity changing member 14, so that fluid may be discharged at a portion adjacent to the capacity changing member 14, but the inlet tube 144, the supply pipe 136c, and the return pipe 138c may move along with movement of the capacity changing member 14 or may be maintained at predetermined positions regardless of the movement of the capacity changing member 14. As described above, unlike the outlet tube 142, the inlet tube 144, the supply pipe 136c, and the return pipe 138c are not particularly limited to positions, and thus, are not required to have a portion corresponding to the variable length portion 142b.

A sealing member or seal 148, made of an elastic material, for example, rubber, or a soft material, for example, resin, may be disposed at an outer side of the inlet tube 144, the supply pipe 136c, and the return pipe 138c, for example, between the inlet tube 144 and the second hole 144h, between the supply pipe 136c and the third hole 136h, and between the return pipe 138c and the fourth hole 138h. Accordingly, by providing the sealing member 148, excellent fluid-tight structure and insulation characteristics may be achieved. The sealing member 148 may be formed as an O-ring member, for example. The sealing member 148 may be formed as a dynamic O-ring, which may be moved easily under pressure while maintaining sealing characteristics, or may be formed as a fixed O-ring which is maintained in a fixed state even under pressure.

For example, the sealing member 148 may be formed as a dynamic O-ring, such that a relative position of the capacity changing member 14 may be moved while upper and lower positions of the inlet tube 144, the supply pipe 136c, and the return pipe 138c are fixed. That is, the inlet tube 144, the supply pipe 136c, and the return pipe 138c may be fixed to the capacity changing member 14 in a manner that enables a relative movement. Accordingly, even when the capacity changing member 14 and the outlet tube 142 connected thereto move, positions of the inlet tube 144 and the hot fluid pipes 136c, 137, and 138c may be fixed, thereby improving structural stability.

Further, the reference level sensor 16 may be disposed at a reference position of the heater tank 10 more specifically, storage space S. For example, the reference level sensor 16 may be disposed on the other side, for example, lower side, opposite to one side where the capacity changing member 14 is disposed. For example, the reference level sensor 16 may be a level switch, and may be, for example, a level switch driven by a mechanical drive method. In this case, if a level of the hot fluid HF, which is sensed by the level switch, is greater than or equal to a predetermined fluid level, the fluid level is maintained without a supply of service fluid; but if the level of the hot fluid HF is below the level switch, the service fluid is introduced into the storage space S of the heater tank 10.

In this case, the reference level sensor 16 may be provided at a reference position, at which a volume of the hot fluid in the storage space S is greater than or equal to a predetermined volume, such that a user may use the hot fluid for a predetermined period of time. For example, the reference position may be a position closer to the capacity changing member 14 than to an inner end portion IE2 of the inlet tube 144, and may be a position closer to the capacity changing member 14 than to the coil 137 for circulation of hot fluid. In this structure, the service fluid introduced through the inlet tube 144 may be heated effectively by the coil 137 for circulation of hot fluid.

The temperature sensor 18 may be provided for the heater tank 10. The temperature sensor 18 may be provided to determine whether to heat the hot fluid HF when temperature of the hot fluid HF is reduced after not being used for a long period of time. In addition, the temperature sensor 18 may be used to determine a temperature when the service fluid or the hot fluid HF in the heater tank 10 is heated. For example, the temperature sensor 18 may be disposed at a position of the coil 137 for circulation of hot fluid or below the position, so as to sense the temperature of the hot fluid HF having a relatively low temperature in the heater tank 10. A temperature sensor having various known structures, and methods, for example, may be used as the temperature sensor 18, and the position of the temperature sensor 18 may be modified in various ways.

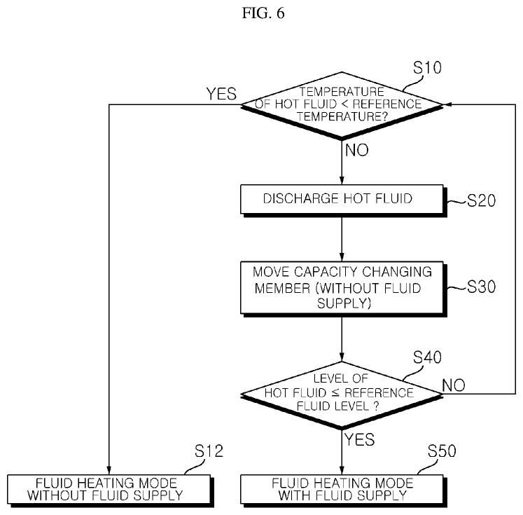

An operation of heater tank 10 described above and a method for controlling the heater tank 10 will be described with reference to FIG. 6, along with FIGS. 1 to 3. The operation of the heater tank 10 and the method for controlling the heater tank 10 may be performed by a controller for operation and control of the heat pump 100, a controller for operation and control of the indoor unit 110, or an individual controller for operation and control of the heater tank 10.

FIG. 6 is a flowchart of a method for controlling heater tank 10 according to an embodiment. Referring to FIG. 6, in determining of temperature of hot fluid, such as water (S10), it is determined whether the temperature of hot fluid is lower than a reference temperature. If the temperature of hot fluid is lower than the reference temperature, a fluid heating mode without fluid supply (S12) is performed. More specifically, in the determining of the temperature of hot fluid (S10), if the temperature of the hot fluid HF, which is sensed by temperature sensor 18, is lower than the reference temperature, a fluid heating mode is performed in which service fluid, such as water or the hot fluid HF in the heater tank 10 is heated by circulating the service fluid, heat-exchanged by the indoor heat exchanger 112, through the heating pipes 136c, 137, and 138c by the 3-way valve 118. In this case, the fluid heating mode may be the fluid heating mode without fluid supply (S12), which is performed without the supply of service fluid while discharge of the hot fluid HF is stopped. The fluid heating mode without fluid supply (S12) may be performed when temperature of the hot fluid HF is reduced after the hot fluid HF is not used for a long period of time, for example.

In this case, the fluid heating mode without fluid supply (S12) may be performed continuously until temperature of the hot fluid HF, sensed by the temperature sensor 18, reaches a predetermined value. Once the temperature of the hot fluid HF, sensed by the temperature sensor 18, reaches the predetermined value, the fluid heating mode without fluid supply (S12) ends, and the determining of the temperature of hot fluid (S10) is performed until the hot fluid is discharged (S20).

While FIG. 6 illustrates an example in which the determining of the temperature of hot fluid (S10) is performed at an initial stage, this is merely exemplary for simple illustration and better understanding of embodiments. That is, the determining of the temperature of hot fluid (S10) may be performed continuously regardless of whether the hot fluid is discharged, and if the temperature of the hot fluid is lower than the reference temperature, the fluid heating mode without fluid supply (S12) may be performed.

Further, once the hot fluid is discharged (S20) as a user uses the hot fluid HW, a surface of the hot fluid HF drops. Then, the capacity changing member 14 is moved by an amount, corresponding to a discharge amount, by the drive 146 in one direction, for example, downward direction, thereby reducing the storage space S in which the hot fluid HF is placed (S30). In this case, while the flow rate control valve 144a of the inlet tube 144 is closed so that the service fluid may not flow into the storage space S, the capacity changing member 14 is moved to change a capacity of the storage space, that is, to reduce the capacity.

Once the hot fluid is discharged (S20), it is determined whether a fluid level of the hot fluid HF is lower than or equal to a reference level in determining of a level of the hot fluid (S40). In this case, if the level of the hot fluid HF is higher than a reference fluid level, the methods waits until the hot fluid is discharged (S20) while the determining of the temperature of the hot fluid (S10) is performed. If the level of the hot fluid HF is lowered than or equal to the reference fluid level as the hot fluid HW is discharged, a fluid heating mode with fluid supply (S50) is performed. More specifically, if reference level sensor 16 senses that the level of the hot fluid HF is lower than or equal to the reference fluid level, the service fluid or the hot fluid HW in the heater tank 10 is heated by circulating the service fluid heat-exchanged by the indoor heat exchanger 112 by the 3-way valve 118. The fluid heating mode with fluid supply (S50) may be performed when the level of the hot fluid HF is lowered due to discharge of the hot fluid HF, for example. As described above, the fluid heating mode with fluid supply (S50) is performed when the level of the hot fluid HF is lower than or equal to the reference fluid level, such that the fluid heating mode with fluid supply (S50) may be performed by supplying the service fluid when discharge of the hot fluid HF is stopped.

More specifically, in the fluid heating mode with fluid supply (S50), the service fluid may be introduced repeatedly at predetermined intervals. That is, the fluid heating mode with fluid supply (S50) may be performed by repeating, a plurality of number of times, a fluid supply period in which while continuously performing the fluid heating mode, the flow rate control valve 144a is temporarily opened to allow the service fluid to be supplied in an amount corresponding to a portion of a required amount, and a fluid supply blocking period in which the flow rate control valve 144a is closed to block the supply of service fluid. This is for the purpose of preventing a problem, which may occur when the temperature of the hot fluid HF is sharply reduced, by providing the fluid supply blocking period in consideration of a rising temperature of the hot fluid in the heater tank 10. The fluid heating mode with fluid supply (S50) may be performed when the capacity changing member 50 is located at an initial position, that is, position corresponding to a maximum capacity of the storage space S, and may be performed continuously until the temperature of the hot fluid HF, which is sensed by the temperature sensor 18, reaches a predetermined value. If the hot fluid HF is discharged during the fluid heating mode with fluid supply (S50), the fluid heating mode with fluid supply (S50) is temporarily stopped during the discharge of the hot fluid HF, and after the discharge of the hot fluid HF is stopped, the fluid heating mode with fluid supply (S50) may be performed again. Even when the fluid heating mode with fluid supply (S50) is temporarily stopped, heating may be performed continuously through the pipe members 136c, 137, and 138. The state in which the heating mode with fluid supply (S50) is temporarily stopped may indicate a state in which at least the fluid supply period is not performed. When the capacity changing member 50 is located at the initial position, and the temperature of the hot fluid HF, sensed by the temperature sensor 18, reaches the predetermined value, the fluid heating mode with fluid supply (S50) ends, and the method waits until the hot fluid is discharged (S20) while the determining of the temperature of the hot fluid (S10) is performed.

As described above, in this embodiment, the supply of service fluid, having a lower temperature than the temperature of the hot fluid HF, is blocked when the hot fluid WF is discharged, thereby preventing or minimizing a temperature gradient or stratification which may occur when fluid having a relatively low temperature is introduced. That is, by changing a capacity of the storage space S in real time as the hot fluid HF is used, the stratification or temperature gradient may be prevented or minimized. Accordingly, the temperature of the hot fluid HF may be maintained as high as possible, and the influence of an external environment may be minimized. Further, the fluid heating mode with fluid supply (S50) is performed only when a level of the hot fluid HF is lower than or equal to the reference level, such that a number of times and a period of the fluid heating mode for heating the hot fluid HF in the heater tank 10 may be reduced. In addition, the fluid heating mode with fluid supply (S50) is performed by supplying service fluid while the discharge of the hot fluid HF is stopped, such that turbulence occurs in the heater tank 10 due to a high Reynolds number, and heat transfer may take place by forced convection. In this case, compared to natural convection, thermal resistance may be significantly reduced, thereby greatly improving heat exchange efficiency.

In the aforementioned embodiments, when the hot fluid HF is discharged in the fluid heating mode with fluid supply (S50), the fluid heating mode with fluid supply (S50), more particularly, the fluid supply period, is temporarily stopped, and after discharge of the hot fluid HF is stopped, the fluid heating mode with fluid supply (S50), more particularly, the fluid supply period, is performed again. By providing the reference level sensor 18, a sufficient amount of the hot fluid HF which is basically stored may be secured, such that even when the supply of service fluid is stopped during discharge of the hot fluid HF, a sufficient amount of hot fluid HF may be discharged. However, embodiments are not limited thereto. Accordingly, various modifications may be made, in which if a supply of fluid is required, such as in the case in which an amount of the hot fluid HF is insufficient in the fluid heating mode with fluid supply (S50), service fluid may be supplied by sensing a discharge amount and temperature of the hot fluid HF, for example.

Embodiments disclosed herein provide a heater tank for a heat pump system, which may improve heat exchange efficiency, and a method for controlling a heater tank. More specifically, embodiments disclosed herein provide a heater tank for a heat pump system, in which a number of times and a period of heating of a fluid, such as hot water may be reduced while maintaining the hot fluid at a high temperature. More particularly, stratification may be prevented or minimized, and heat transfer may take place by forced convection during heating, thereby improving heat exchange efficiency.

In accordance with embodiments disclosed herein, a heater tank for a heat pump system has a structure in which a capacity of a storage space is changed as hot fluid is discharged. For example, the heater tank according to embodiments disclosed herein may include a main body having an internal space and one open side, and a capacity changing member forming a storage space, in which hot fluid is stored, by closing the one open side in the internal space of the main body, and being moved so that a capacity of the storage space is changed as the hot fluid is discharged. In this case, the heater tank may further include an inlet tube fixedly installed at the capacity changing member and having a flow rate control valve, in which when the hot fluid is discharged, the flow rate control valve may be closed to block inflow of service fluid.

The outlet tube may be moved along with the capacity changing member, such that even when the capacity changing member is moved, a constant distance may be maintained between an inner end portion of the outlet tube, positioned inside of the storage space, and the capacity changing member. Alternatively, the outlet tube may include a variable length portion fixedly installed at the capacity changing member and formed at an outer portion thereof, and having a variable length. The variable length portion may be made of a flexible material or an elastic material, which is different from other portions of the outlet tube, or may have a corrugated shape. For another example, the outlet tube may have a double pipe structure with an inner tube and an outer tube, such that the variable length portion may be formed by a variable length of an overlapping portion of the inner tube and the outer tube.

According to embodiments disclosed herein, the capacity changing member may include an inner portion made of a hard material, and a pressed portion formed along an outer edge of the inner portion and made of an elastic material or a soft material, thereby forming a stable fluid-tight structure. The capacity changing member may be formed as a floating disk which floats on the hot fluid by buoyancy, and a driving member (drive) that provides a drive force that moves the capacity changing member may be coupled to the capacity changing member. In this case, by balance between buoyancy and the drive force, the capacity changing member may form a stable fluid-tight structure.

According to embodiments disclosed herein, the heater tank may further include a reference level sensing member or sensor disposed at a reference position of the storage space. When the capacity changing member is positioned at a reference fluid level or below as the hot fluid is discharged, the service fluid may be introduced into the heater tank to be heated while discharge of the hot fluid is stopped.

In accordance with embodiments disclosed herein, there is provided a method for controlling a heater tank for a heat pump system, in which when a hot fluid, such as water is discharged from the heater tank having the aforementioned structure, the capacity changing member may be moved so that a capacity of the storage space is changed, while inflow of the feed fluid is blocked. In response to a level of the hot fluid being lower than or equal to a reference fluid level as the hot fluid is discharged, a fluid heating mode with fluid supply is performed in which heating is performed by supplying service fluid. The fluid heating mode with fluid supply may be performed while discharge of the hot fluid is blocked. In the fluid heating mode with fluid supply, a fluid supply period and a fluid supply blocking period are performed repeatedly while the hot fluid is heated continuously, and in response to the capacity changing member or a fluid surface being located at an initial position and a fluid temperature, sensed by a fluid temperature sensor, reaching a predetermined value, the fluid heating mode with fluid supply may end. In response to the temperature of the hot fluid being lower than a reference temperature, a fluid heating mode without fluid supply may be performed in which heating is performed without supplying the service fluid.

In embodiments disclosed herein, when hot fluid is discharged, supply of service fluid having a lower temperature than the hot fluid is blocked, thereby preventing or minimizing stratification which may occur when service fluid having a relatively low temperature is introduced during the discharge of the hot fluid. That is, a capacity of a storage space is changed in real time as the hot fluid is used, thereby preventing or minimizing stratification or temperature gradient. Accordingly, the temperature of the hot fluid may be maintained as high as possible, and the influence of an external environment may be minimized.

Further, a fluid heating mode with fluid supply may be performed only when a level of the hot fluid is lower than or equal to a reference fluid level, such that a number of times, and a period, for example, of a fluid heating mode for heating the hot fluid in the heater tank may be reduced. In addition, the fluid heating mode with fluid supply is performed by supplying fluid while the discharge of the hot fluid is stopped, such that turbulence occurs in the heater tank due to a high Reynolds number, and heat transfer may take place by forced convection. In this case, compared to natural convection, thermal resistance may be significantly reduced, thereby greatly improving heat exchange efficiency.

The features, structures, effects, and the like described in the above-described embodiments include at least one embodiment, but embodiments are not limited only to one embodiment. Further, the features, structures, effects, and the like illustrated in each embodiment may be combined or modified to other embodiments by those skilled in the art. Therefore, contents related to the combination or the modification should be interpreted to be included in the scope.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heater tank for a heat pump system, the heater tank comprising:
a main body having an internal space and one open side; and
a capacity changing member that forms a storage space, in which hot fluid is stored, by closing the one open side in the internal space of the main body, and being moved so that a capacity of the storage space is changed as the hot fluid is discharged.

2. The heater tank of claim 1, further comprising an inlet tube fixedly installed at the capacity changing member and having a flow rate control valve.

3. The heater tank of claim 2, wherein when the hot fluid is discharged, the flow rate control valve is closed to block inflow of service fluid.

4. The heater tank of claim 1, further comprising an outlet tube fixedly installed at the capacity changing member, wherein the outlet tube is moved along with the capacity changing member, such that even when the capacity changing member is moved, a constant distance is maintained between an inner end of the outlet tube, positioned inside of the storage space, and the capacity changing member.

5. The heater tank of claim 1, wherein the outlet tube comprises a variable length portion fixedly installed at the capacity changing member and formed at an outer portion thereof, and having a variable length.

6. The heater tank of claim 5, wherein:
the variable length portion is made of a flexible material or an elastic material, which is different from other portions of the outlet tube; or
the variable length portion has a corrugated shape; or
the outlet tube has a double pipe structure with an inner tube and an outer tube, such that the variable length portion is formed by a variable length of an overlapping portion of the inner tube and the outer tube.

7. The heater tank of claim 1, wherein the capacity changing member comprises an inner portion made of a hard material, and a pressed portion formed along an outer edge of the inner portion and made of an elastic material or a soft material.

8. The heater tank of claim 1, wherein:
the capacity changing member is formed as a floating disk that floats on the hot fluid by buoyancy; and
a drive that provides a drive force that moves the capacity changing member is coupled to the capacity changing member.

9. The heater tank of claim 1, further comprising a reference level sensor disposed at a reference position of the storage space.

10. The heater tank of claim 1, wherein in response to the capacity changing member being positioned at a reference fluid level or below, the service fluid is introduced into the heater tank to be heated while discharge of the hot fluid is stopped.

11. The heater tank of claim 1, wherein the capacity changing member comprises a plate having a predetermined thickness.

12. A method for controlling a heater tank for a heat pump system, the heater tank comprising a main body having an internal space and one open side, a capacity changing member that forms a storage space, in which hot fluid is stored, by closing the one open side in the internal space of the main body, and having an inlet tube to supply service fluid to the storage space and an outlet tube through which the hot fluid is discharged, the method comprising:
discharging the hot fluid from the heater tank;
when the hot fluid is discharged, moving via a drive the capacity changing member so that a capacity of the storage space is changed; and
blocking inflow of the service fluid during the moving of the capacity changing member.

13. The method of claim 12, further comprising:
in response to a level of the hot fluid being lower than or equal to a reference fluid level as the hot fluid is discharged, performing a fluid heating mode with fluid supply in which heating is performed by supplying the service fluid.

14. The method of claim 13, further comprising:
performing the fluid heating mode with fluid supply while discharge of the hot fluid is blocked.

15. The method of claim 12, further comprising:
in the fluid heating mode with fluid supply, performing a fluid supply period and a fluid supply blocking period repeatedly while the hot fluid is heated continuously; and
in response to the capacity changing member being located at an initial position and a temperature, sensed by a temperature sensor, reaching a predetermined value, ending the fluid heating mode with fluid supply.

16. The method of claim 12, further comprising:
in response to a temperature of the hot fluid being lower than a reference temperature, performing a fluid heating mode without fluid supply in which heating without supplying the service fluid.

17. The method of claim 12, wherein the fluid outlet tube is fixedly installed at the capacity changing member, and wherein the outlet tube is moved along with the capacity changing member, such that even when the capacity changing member is moved, a constant distance is maintained between an inner end of the outlet tube, positioned inside of the storage space, and the capacity changing member.

18. The method of claim 17, wherein the outlet tube comprises a variable length portion fixedly installed at the capacity changing member and formed at an outer portion thereof, and having a variable length.

19. The method of claim 18, wherein:
the variable length portion is made of a flexible material or an elastic material, which is different from other portions of the outlet tube; or
the variable length portion has a corrugated shape; or
the outlet tube has a double pipe structure with an inner tube and an outer tube, such that the variable length portion is formed by a variable length of an overlapping portion of the inner tube and the outer tube.

20. The method of claim 19, wherein the capacity changing member comprises an inner portion made of a hard material, and a pressed portion formed along an outer edge of the inner portion and made of an elastic material or a soft material.

21. The method of claim 19, wherein:
the capacity changing member is formed as a floating disk which floats on the hot fluid by buoyancy; and
a drive that provides a drive force that moves the capacity changing member is coupled to the capacity changing member.

22. The heater tank of claim 12, wherein the capacity changing member comprises a plate having a predetermined thickness.

23. A heater tank for a heat pump system, the heater tank comprising:
a main body having an internal space and one open side; and
a movable plate that forms a fluid-tight storage space, in which hot fluid is stored, by closing the one open side in the internal space of the main body, the movable plate being moved so that a capacity of the storage space is changed as the hot fluid is discharged.

24. The heater tank of claim 23, further comprising an inlet tube fixedly installed at the movable plate and having a flow rate control valve, wherein when the hot fluid is discharged, the flow rate control valve is closed to block inflow of service fluid.

25. The heater tank of claim 23, further comprising an outlet tube fixedly installed at the movable plate, wherein the outlet tube is moved along with the movable plate, such that even when the movable plate is moved, a constant distance is maintained between an inner end of the outlet tube, positioned inside of the storage space, and the movable plate.

26. The heater tank of claim 23, wherein the outlet tube comprises a variable length portion fixedly installed at the movable plate and formed at an outer portion thereof, and having a variable length, wherein:
the variable length portion is made of a flexible material or an elastic material, which is different from other portions of the outlet tube; or
the variable length portion has a corrugated shape; or
the outlet tube has a double pipe structure with an inner tube and an outer tube, such that the variable length portion is formed by a variable length of an overlapping portion of the inner tube and the outer tube.

27. The heater tank of claim 23, wherein:
the movable plate floats on the hot fluid by buoyancy; and
a drive that provides a drive force that moves the movable plate is coupled to the movable plate.
